(19) United States
(12) Patent Application Publication
(10) Pub. No.: US 2007/0163140 A1
(43) Pub. Date: Jul. 19, 2007

(54) Shopping cart dryer

(76) Inventors: Sherri Costello, Monrovia, CA (US); Tamla Stubbs, Monrovia, CA (US)

Correspondence Address: Charles R. Sutton;LAW OFFICES OF ROGER C. HSU, Ste. 302, 201 S. Lake Ave., Pasadena, CA, 91101, US

(21) Appl. No.: 11/333,474

(22) Filed: Jan. 17, 2006

(51) Int. Cl. F26B 25/06; F26B 19/00; F26B 21/00

(52) U.S. Cl. 34/89; 34/202; 34/524

(57) ABSTRACT

A machine which rapidly dries shopping carts after they have been washed or used in the rain. It consists of an arch-like superstructure tall enough for a typical shopping cart to fit through. In the body of the arch-like superstructure are fans which blow through a parabolic focusing funnel to increase the force of the breeze. The breeze is directed inward toward the passage through which the shopping carts are introduced. Baffles deflect the breeze in many directions to ensure complete drying of all the grids and interstices, both top and bottom of the shopping carts. Heat lamps may also be mounted within the arch-like superstructure for the purpose of increasing the temperature, and therefore the drying tendencies of the passage under the arch. The invention comes equipped with a switch by which it can be turned on or off. This switch may take the form of a motion or metal detector to make the device turn on and off automatically when presented with a shopping cart.

### CROSS REFERENCE TO RELATED APPLICATIONS

There are no related applications.

### STATEMENT REGARDING FEDERALLY SPONSORED RESEARCH OF DEVELOPMENT

This application was not made using federally sponsored research and development. The inventors retain all rights.

### BACKGROUND OF THE INVENTION

Shopping carts are frequently used outdoors. Their purpose is to assist the shopper in transporting goods not only inside the store, but also out to his or her car after the goods are purchased. During periods of rain, the shopping carts can become wet while they are outdoors. When they are brought back inside the store, they drip water on the floor and create an unsafe condition in which the business invitees of the store may slip and fall. Also the carts can become dirty with use making it necessary to clean the carts such as by steam cleaning. Again, the carts may drip water inside the store when they have been cleaned.

The current method of drying the carts consists of either the tedious practice of towel drying them, or simply allowing them to air dry over time. With towel drying, much expensive employee time must be used to dry each cart. With air drying the carts are out of service for a long time, or they are pressed into service before they are completely dry (again leading to the dangerous condition caused by dripping).

### BRIEF SUMMARY OF THE INVENTION

This is a machine which rapidly dries shopping carts after they have been washed or used in the rain. It consists of an arch-like superstructure tall enough for a typical shopping cart to fit through. In the body of the arch-like superstructure are fans which blow through a parabolic focusing funnel to increase the force of the breeze. The breeze is directed inward toward the passage through which the shopping carts are introduced. Baffles deflect the breeze in many directions to ensure complete drying of all the grids and interstices, both top and bottom of the shopping carts. Heat lamps may also be mounted within the arch-like superstructure for the purpose of increasing the temperature, and therefore the drying tendencies of the passage under the arch. The invention comes equipped with a switch by which it can be turned on or off. This switch may take the form of a motion or metal detector to make the device turn on and off automatically when presented with a shopping cart.

### BRIEF DESCRIPTION OF THE SEVERAL VIEWS OF THE DRAWINGS

FIG. 1 is an end-on view of the invention showing a typical shopping cart passing under it.

FIG. 2 is a partial cutaway view showing the internal parts of the invention.

FIG. 3 is a partially exploded diagram showing the blowing mechanism of the invention.

FIG. 4 is a partially exploded diagram showing the heat lamp mechanism of the invention.

### DETAILED DESCRIPTION OF THE INVENTION

A machine which rapidly dries shopping carts after they have been washed or used in the rain. It consists of an arch-like superstructure tall enough for a typical shopping cart to fit through. In the body of the arch-like superstructure are fans which blow through a parabolic focusing funnel to increase the force of the breeze. The breeze is directed inward toward the passage through which the shopping carts are introduced. Baffles deflect the breeze in many directions to ensure complete drying of all the grids and interstices, both top and bottom of the shopping carts. Heat lamps may also be mounted within the arch-like superstructure for the purpose of increasing the temperature, and therefore the drying tendencies of the passage under the arch. The invention comes equipped with a switch by which it can be turned on or off. This switch may take the form of a motion or metal detector to make the device turn on and off automatically when presented with a shopping cart.

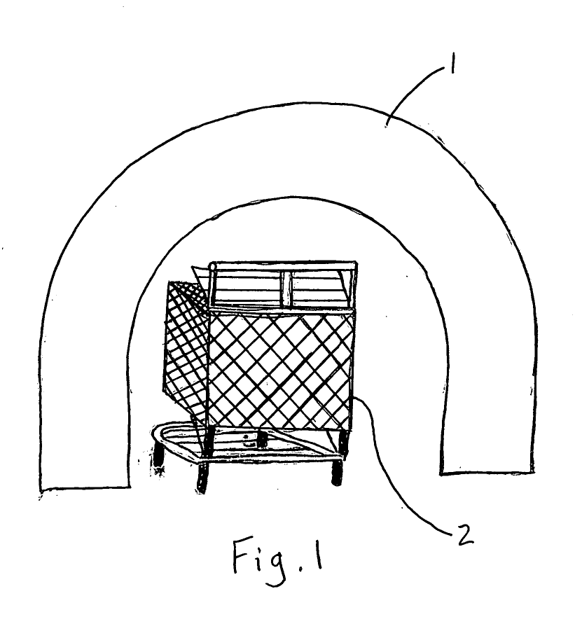

Referring now to FIG. 1 the superstructure (1) of the invention can be seen with a typical shopping cart (2). As can be seen, the shopping cart can fit through the arch of the invention but there is not a large amount of room on the various sides. The shopping cart fits closely through the invention so the force of the drying air is maximized rather than diminished by too much room between the cart and the blowers. This invention can be practiced using superstructures of other shapes (such as rectangles). The point is not the shape of the passage, but rather that there is a passage through which shopping carts fit closely and inside of which they are subject to blowing air, and perhaps heat lamps.

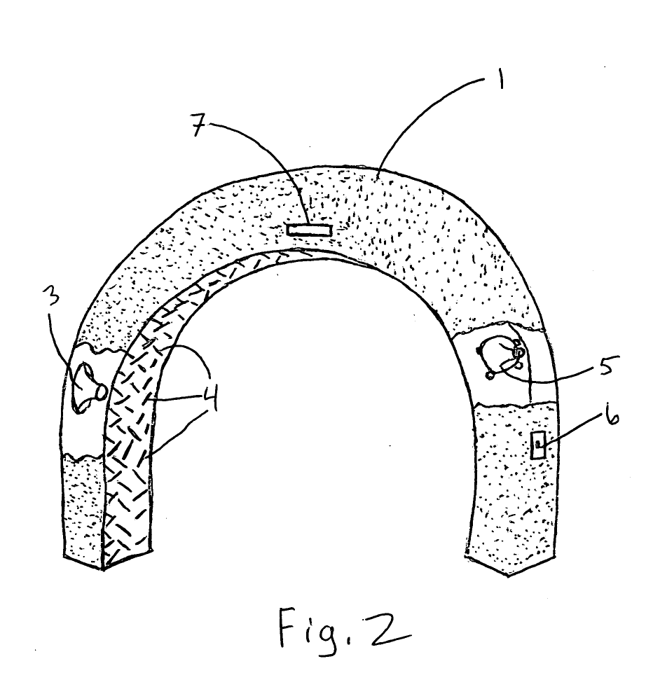

Referring now to FIG. 2, the superstructure (1) can be seen to be hollow and to contain one or more blower mechanisms (3) which forces air through baffles (4) on the inner face of the superstructure (1) of the invention. There may also be one or more heat lamps (5) in the superstructure adapted to bring thermal energy to bear on the wet shopping carts in order to dry them more efficiently. The invention comes with a switch (6) by which it can be turned on and off. There may be a sensor (7) which turns the invention on and off automatically when shopping carts are introduced. This sensor can sense through a variety of means, but typical applications might use either a motion sensor or a metal detector as the sensor (7).

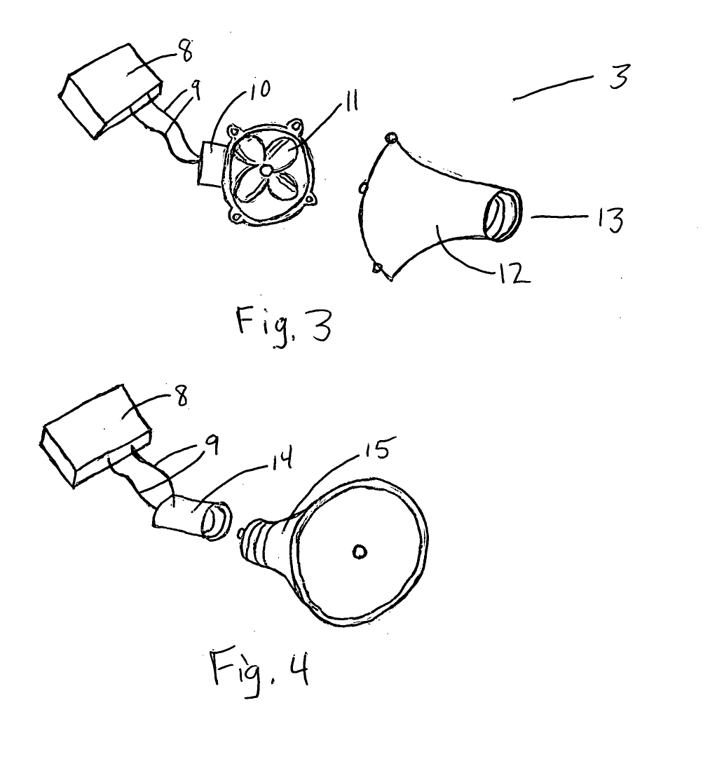

Referring now to FIG. 3, the blower mechanism (3) is shown partially exploded to show that it has an energy source (8) using circuit wires (9) to operate a motor (10) which in turn operates a fan (11). The fan (11) forces air through a funnel (12) to an opening (13) from which the air exits at increased pressure. Referring now to FIG. 4, the heat lamp (5) is shown partially exploded to reveal it has an energy source (8) using circuit wires (9) to empower a socket (14) into which can be screwed a heat bulb (15).

Persons skilled in the electronic arts will be able to see that the addition of the switches shown at FIG. 2 into the simple circuits shown at FIGS. 3 and 4 will permit the operator to turn the invention on and off. Also the addition of fuses, resistors, relays, transistors, and capacitors in manners already known can be used to make these simple circuits more reliable by reducing the likelihood of a short circuit or power surge which could damage the fan (11) or heat bulb (15).

The preferred embodiment features a superstructure which is a parabolic arch with legs having a cross section that is a rectangle having sides of two to three feet. Within the framework of this superstructure the blowers, baffles and heat lamps are supported so their respective evaporative conditions are brought to bear inwardly. The force of the air and the heat from the lamps remove the water from the carts as the carts are passed under the arch of the superstructure.

We claim:

1. A shopping cart dryer comprising: a superstructure having legs and forming an aperture through which shopping carts can pass, said aperture having an inside, said inside supporting drying means directed inwardly toward said aperture; and
said drying means acting on said shopping carts so as to remove moisture from said shopping carts.

2. The shopping cart dryer of claim 1 further comprising:
said drying means is a fan having an air screw, a motor, and a circuit; and
said circuit being adapted to operate said motor and having an input and an output; said input and
output being adapted to supply power to said circuit by connecting to poles of an electricity source.

3. The shopping cart dryer of claim 2 further comprising:
said circuit has a socket adapted to hold and operate a heat lamp; and
said heat lamp being directed inwardly toward said aperture.

4. The shopping cart dryer of claim 2 further comprising:
a switch placed in series with said circuit, said switch being operable to open or close said circuit.

5. The shopping cart dryer of claim 4 further comprising:
a motion detector connected to said switch; and
said motion detector operating said switch so as to close said circuit when a workpiece is placed into said aperture.

6. The shopping cart dryer of claim 4 further comprising:
a metal detector connected to said switch: and said metal detector operating said switch so as to close said circuit when a metallic workpiece is placed into said aperture.

7. The shopping cart dryer of claim 1 further comprising:
said drying means is a heat lamp having a circuit;
said circuit having a socket; and
said socket being adapted to hold and operate a heat lamp bulb.

8. The shopping cart dryer of claim 7 further comprising:
a switch placed in series with said circuit, said switch being operable to open or close said circuit.

9. The shopping cart dryer of claim 8 further comprising:
a motion detector connected to said switch; and
said motion detector operating said switch so as to close said circuit when a workpiece is placed into said aperture.

10. The shopping cart dryer of claim 8 further comprising:
a metal detector connected to said switch: and
said metal detector operating said switch so as to close said circuit when a metallic workpiece is placed into said aperture.
